(19) United States
(12) Patent Application Publication
(10) Pub. No.: US 2024/0357708 A1
(43) Pub. Date: Oct. 24, 2024

(54) ELIMINATING OR MINIMIZING INTERFERENCE BETWEEN HANDS ON DETECTION SENSOR AND HEATER IN STEERING WHEELS

(71) Applicant: GENTHERM GMBH, Odelzhausen (DE)

(72) Inventors: Nikolay H. IORDANOV, Windsor (CA); Jan BESKA, Belle River (CA)

(21) Appl. No.: 18/686,935

(22) PCT Filed: Aug. 29, 2022
(86) PCT No.: PCT/US2022/041805

§ 371 Date: Feb. 27, 2024

Related U.S. Application Data
(60) Provisional application No. 63/239,695, filed on Sep. 1, 2021.

(51) Int. Cl. H05B 1/02; B60N 2/56; B62D 1/06; G01V 3/08; H05B 3/56

(52) U.S. Cl. CPC H05B 1/0238; B60N 2/5685; B62D 1/065; G01V 3/088; H05B 3/56

(57) ABSTRACT

A heater/sensor assembly comprises a sensor assembly and a heater assembly. The sensor assembly comprises a first sheet of an electrically non-conducting material, a first wire attached to a first side of the first sheet, and a second wire arranged parallel to the first wire and attached to a second side of the first sheet that is opposite the first side. The heater assembly comprises a second sheet of the electrically non-conducting material arranged parallel to the first sheet; a third wire attached to a first side of the second sheet facing the second side of the first sheet; and a fourth wire arranged parallel to the third wire and attached to a second side of the second sheet that is opposite the first side of the second sheet. The third and fourth wires are arranged at an angle relative to the first and second wires.

### CROSS-REFERENCE TO RELATED APPLICATIONS

This application claims the benefit of U.S. Provisional Application No. 63/239,695, filed on Sep. 1, 2021. The entire disclosure of the application referenced above is incorporated herein by reference

### FIELD

The present disclosure relates generally to automotive heating and hands on detection sensing systems and more particularly to eliminating or minimizing interference between hands on detection sensor and heater in steering wheels.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles such as partially or fully autonomous vehicles may include an autonomous vehicle control system that automatically controls driving of the vehicle under certain conditions. The autonomous vehicle control systems typically include a navigation system, an array of external sensors such as radar or Lidar sensors, and actuators that control steering, braking, and acceleration of the vehicle.

For partially autonomous vehicles, certain driving situations may require a driver to intervene and/or take over driving of the vehicle. For example, driving on a highway may be handled by the autonomous vehicle control system. Driver intervention may be requested in the event of an accident or construction on the roadway or when the vehicle starts exiting the highway. Accordingly, the vehicles need to sense whether or not an occupant's hand or hands are on the steering wheel of the vehicle prior to disengaging the vehicle control system. Sensors located in seats of the vehicle may also be used to detect the presence or absence of an occupant of the vehicle. If an occupant's presence is detected, safety restraints such as air bags and seat belt pretensioners may be selectively enabled or disabled.

### SUMMARY

A heater/sensor assembly to perform heating of a surface and proximity sensing comprises a sensor assembly and a heater assembly arranged adjacent to the sensor assembly. The sensor assembly comprises a first sheet of an electrically non-conducting material, a first wire attached to a first side of the first sheet, and a second wire arranged parallel to the first wire and attached to a second side of the first sheet that is opposite the first side. The heater assembly comprises a second sheet of the electrically non-conducting material arranged parallel to the first sheet, a third wire attached to a first side of the second sheet facing the second side of the first sheet, and a fourth wire arranged parallel to the third wire and attached to a second side of the second sheet that is opposite the first side of the second sheet. The third and fourth wires are arranged at an angle relative to the first and second wires.

In another feature, the angle is greater than zero and less than or equal to 90 degrees.

In another feature, the second and third wires contact each other.

In another feature, the first, second, third, and fourth wires are made of an electrically conducting material and are electrically uninsulated.

In other features, the second and third wires are made of an electrically conducting material, and one of the second and third wires is electrically insulated.

In other features, the second and third wires are made of an electrically conducting material, and at least one of the second and third wires is electrically uninsulated. The heater/sensor assembly further comprises a layer of an electrically non-conducting material disposed between the second and third wires.

In other features, a system comprises the heater/sensor assembly, a first circuit configured to control power supply to the fourth wire, and a second circuit configured to output a signal to the first wire and to sense a capacitance based on a frequency of the signal.

In another feature, the first circuit and the second circuit operate independently of each other.

In another feature, the second and third wires are connected to a reference potential.

In other features, the second and third wires are made of an electrically conducting material. One of the second and third wires is electrically insulated. At least one of the first circuit and the second circuit outputs a respective signal to the second and third wires.

In other features, the second and third wires are made of an electrically conducting material and are uninsulated. The heater/sensor assembly further comprises a layer of an electrically non-conducting material disposed between the second and third wires. At least one of the first circuit and the second circuit outputs a respective signal to the second and third wires.

In other features, at least one of the first, second, third, and fourth wires includes a single strand wire.

In other features, at least one of the first, second, third, and fourth wires includes a multi-strand wire.

In other features, a steering wheel of a vehicle comprises the heater/sensor assembly. A cover layer is arranged adjacent to the first wire. The cover layer is electrically non-conducting. A first adhesive layer is disposed between the cover layer and the first wire to adhere the first wire to the cover layer. The first adhesive layer is electrically non-conducting. A second adhesive layer is disposed between the fourth wire and a base portion of the steering wheel to adhere the fourth wire to the base portion of the steering wheel. The second adhesive layer is electrically non-conducting.

In other features, a system comprises the steering wheel, a first circuit configured to control power supply to the fourth wire, and a second circuit configured to output a signal to the first wire and to sense a capacitance based on a frequency of the signal.

In other features, the first circuit and the second circuit operate independently of each other.

In other features, a seat of a vehicle comprises the heater/sensor assembly disposed in a seat portion of the seat of the vehicle. The first wire is proximate to and faces an upper region of the seat portion. The fourth wire faces a lower region of the seat portion. A cover layer is arranged in the upper region of the seat portion adjacent to the first wire. The cover layer is electrically non-conducting. A first adhesive layer is disposed between the cover layer and the first wire to adhere the first wire to the cover layer. The first adhesive layer is electrically non-conducting. A second adhesive layer is disposed between the fourth wire and the lower region of the seat portion to adhere the fourth wire to the lower region of the seat portion. The second adhesive layer is electrically non-conducting.

In other features, a system comprises the seat, a first circuit configured to control power supply to the fourth wire, and a second circuit configured to output a signal to the first wire and to sense a capacitance based on a frequency of the signal.

In other features, the first circuit and the second circuit operate independently of each other.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view of an example of a steering wheel including a capacitive sensing and heating system with a heater/sensor assembly according to the present disclosure;

FIG. 2 is a side view of an example of a seat including a capacitive sensing and heating system with a heater/sensor assembly according to the present disclosure;

FIGS. 3A and 3B show a capacitive sensing portion of the heater/sensor assembly according to the present disclosure;

FIGS. 4A and 4B show a heater portion of the heater/sensor assembly according to the present disclosure;

FIGS. 5A and 5B show the heater/sensor assembly including the capacitive sensing portion and the heater portion according to the present disclosure;

FIG. 6 shows a manner of disposing the heater/sensor assembly in a steering wheel or a seat of a vehicle according to the present disclosure; and

FIG. 7 shows a non-limiting example of a capacitive sensing and heating system comprising a capacitive sensing controller and a heating controller according to the present disclosure.

In the drawings, reference numbers may be reused to identify similar and/or identical elements.

### DETAILED DESCRIPTION

Hands on detection sensors include capacitive sensors that are typically embedded in steering wheels along with heaters used to heat the steering wheels. The present disclosure provides separate heater and sensor elements, each with separate shields arranged next to each other. Each shield includes wires that are arranged in a different orientation relative to each other, which reduces their overlap to eliminate or minimize electrical interference between the heater and the sensor elements.

Specifically, the present disclosure provides a design and structural arrangement for the heater and the hands on detection sensor for eliminating or minimizing interference between the hands on detection sensor and the heater in a steering wheel without adding a dedicated shield layer between the hands on detection sensor and the heater. Instead, as explained below in detail, a shielding wire is employed in each of a hands on detection sensor mat and a heater mat, which after assembling into the steering wheel, provide shielding between the hands on detection sensor and the heater. Additionally, for eliminating or maximally reducing interference between the hands on detection sensor and the heater, the wires sewed on the sensor and heater mats can be oriented perpendicularly (or in other orientations), providing minimum overlapping between the two mats.

Typically, two methods are used for eliminating or maximally reducing the interference between the hands on detection sensor and the heater. A first method involves adding a conductive shield layer between the hands on detection sensor and the heater. A second method involves synchronising the controls for the hands on detection sensor and heater, with each control functioning in separate timeslots. The first method is expensive due to the addition of material to the steering wheel. The second method is not applicable in cases where the control systems for the hands on detection sensor and the heater need to be independent, for example, because the control systems are provided by two different suppliers.

The proposed architecture allows independent control of the hands on detection sensor and the heater and eliminates or reduces interference between the hands on detection sensor and the heater. The interference can be eliminated or reduced to a level equal or close to what can be otherwise achieved by adding an extra conductive shield layer made of a metal mesh or a conductive fabric. Avoiding the extra shield conductive layer is advantageous since the extra conductive shield layer adds significant cost, which is eliminated by the proposed architecture.

As explained below in further detail, the proposed architecture includes two features. First, the wires of each of the hands on detection sensor and the heater include an immediate shield on the side of a fleece (i.e., a sheet of a textile material), which provides significant shielding efficiency. Second, the wires sewed on the mats of the hands on detection sensor and the heater are oriented perpendicularly (or in some other orientation) to each other, which provides minimum overlap between the wires and eliminate or minimize the remaining interference not removed by the shielding wires. The combination of these two features allows independent and non-synchronized operation of the hands on detection sensor and the heater.

More specifically, a sensor/heater assembly according to the present disclosure comprises two similar but separate mats (also called pads). A mat comprises a sheet of a textile material (or some other flexible electrically non-conducting material) with conductive wires sewed on both sides of the sheet. Each mat comprises a base made of an electrically non-conductive material (e.g., textile or fleece). Conductive wires are attached symmetrically to both sides of the base. The conductive wires are sewn to the base using an electrically non-conductive material (e.g., a polyester sewing thread). The two mats can be of same size, shape, and material. The two mats differ in that the conductive wires are sewn on one of the mats in a horizontal direction and on the other mat in a vertical direction. Accordingly, when the two mats are stacked (i.e., when one mat is placed on top of the other), the conductive wires on one mat are oriented perpendicularly (or at an angle other than 90 degrees) relative to the conductive wires on the other mat. The angle at which the conductive wires on one mat are oriented relative to the conductive wires on the other mat can be such that the orientation of the conductive wires on one mat relative to the conductive wires on the other mat minimizes the overlap between the conductive wires on the two mats, which in turn minimizes the electrical interference between the two mats.

For example, a first mat can function as a touch or proximity sensor while a second mat can function as a heater. In the first mat, the top side conductive wire is used for touch or proximity sensing. The bottom side conductive wire of the first mat functions as a shield and can be connected to ground or may be driven actively with a first signal. Accordingly, the bottom side conductive wire of the first mat functions as a shield to the top conductive wire of the first mat used for touch or proximity sensing. In the second mat, which serves as a heater, the bottom side conductive wire is used as a heater. The top side conductive wire of the second mat functions as a shield and can be connected to ground or may be driven actively with a second signal. Accordingly, the top side conductive wire of the second mat functions as an additional shield to the top conductive wire of the first mat used for touch or proximity sensing and can shield interference from the heater from affecting the touch or proximity sensing performed by the top side conductive wire of the first mat.

Each mat operates independently of the other mat and is independently controlled by a separate controller. Accordingly, only one mat can be used in a vehicle where either touch only or heat only functionality is desired. When both touch and heat functions are desired (e.g., in a steering wheel and/or a seat of a vehicle), each mat can be sourced from one supplier or from two different suppliers, and the two mats can be stacked and assembled in a steering wheel and/or a seat of a vehicle. For example, the two mats can be integrated in a stacked manner as described above (e.g., the first mat can be placed on top of the second mat). When the two mats are stacked, the two shielding wires of the two mats (i.e., the bottom side conductive wire of the first mat and the top side conductive wire of the second mat) lie in the middle (i.e., between the top side conductive wire of the first mat, also called the sensor wire; and the bottom side conductive wire of the second mat, also called the heater wire). The two shielding wires function effectively as a shield separating the touch/proximity sensor from the heater.

Notably, the shield provided by the two shielding wires is not a defined single layer or core made of an electrically conducting material on which sides the sensing and heater wires are attached. For example, the sensor/heater assembly according to the present disclosure does not include a flat shielding element comprising a fabric of metal threads. Instead, the sensor/heater assembly according to the present disclosure utilizes two fleeces as the bases with the sensor and heater wires sewn on one side of each of the bases and a shield wire sewn on the other side of each of the bases. The heater and sensor elements are separate, each with separate shields arranged next to each other. The shield wires are oriented differently (e.g., perpendicularly) relative to each other to reduce their contact or overlap. The reduced contact or overlap in turn reduces electrical interference between the heater and sensor. These and other features of the present disclosure are described below in detail.

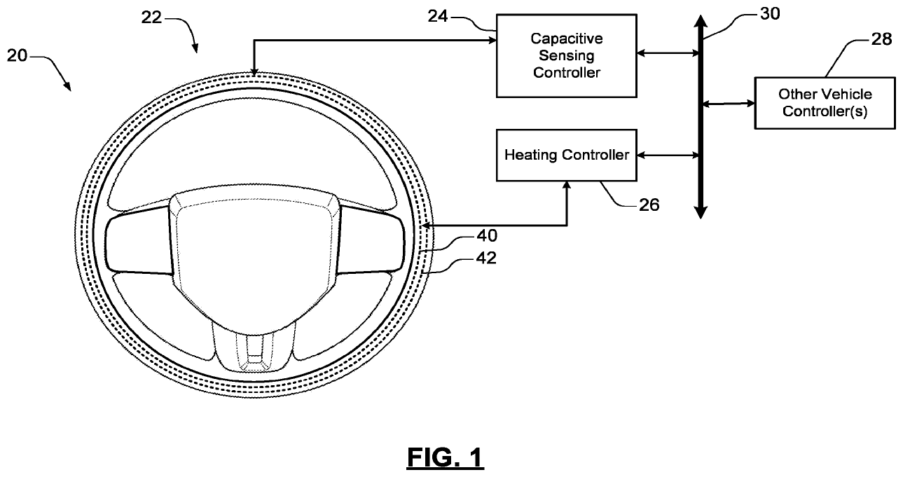

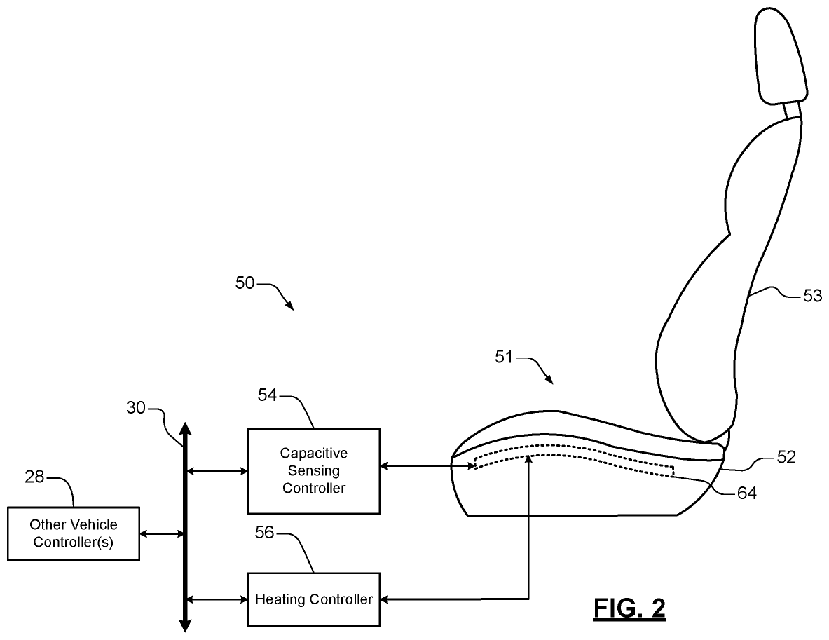

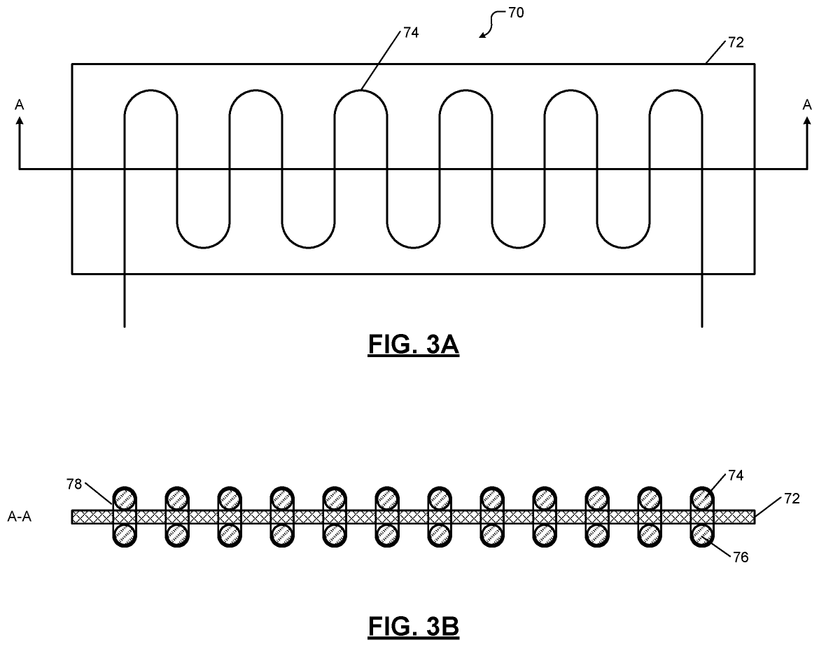

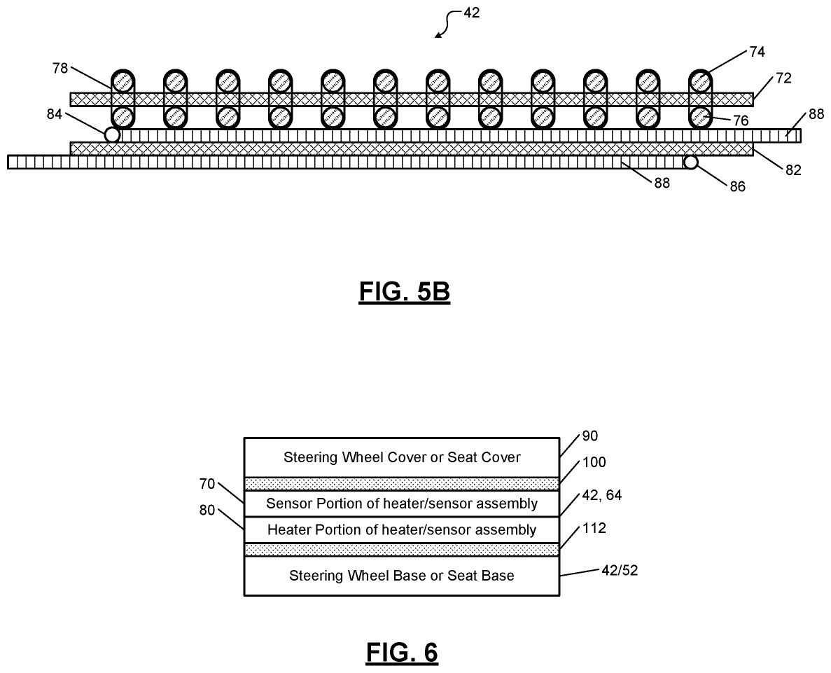

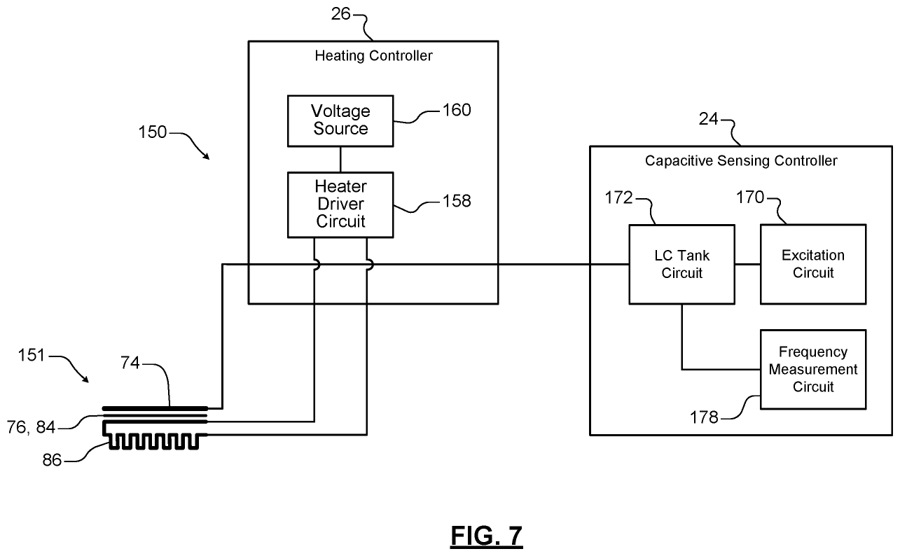

The present disclosure is organized as follows. Initially, examples of the hands on detection sensor and the heater are shown and described with reference to FIGS. 1 and 2. Subsequently, the structure of the hands on detection sensor and the heater is shown and described in detail with reference to FIGS. 3A-5B. A manner of disposing the hands on detection sensor and the heater in a steering wheel or a seat of a vehicle is schematically shown and described with reference to FIG. 6. A non-limiting example of a capacitive sensing and heating system comprising a capacitive sensing controller and a heating controller is shown and described with reference to FIG. 7.

FIG. 1 shows a capacitive sensing and heating system 20 for a steering wheel 22 of a vehicle. The capacitive sensing and heating system 20 includes a capacitive sensing controller 24 and a heating controller 26. The steering wheel 22 includes a heater/sensor assembly 42. The heater/sensor assembly 42 is shown and described below in further detail with reference to FIGS. 3A-5B. The heater/sensor assembly 42 is wrapped around a steering wheel base 40. In some examples, the heater/sensor assembly 42 may define a single heating zone or a plurality of heating zones. The capacitance sensing may also be performed in a single sensing zone or a plurality of sensing zones.

The capacitive sensing controller 24 senses a capacitance of the heater/sensor assembly 42. More specifically, the capacitive sensing controller 24 senses a change in the capacitance that is induced when an occupant of the vehicle places a hand or hands on the steering wheel 22 or when the occupant removes the hand or hands from the steering wheel 22. The heating controller 26 controls supply of power to the heater in the heater/sensor assembly 42. Examples of the capacitive sensing controller 24 and the heating controller 26 are described below in further detail with reference to FIG. 7.

In some examples, one or more switches (not shown) may be used by an occupant of the vehicle to actuate the capacitive sensing and/or heating of the steering wheel 22. For example, the one or more switches may include physical switches or pushbuttons (e.g., on the dashboard of the vehicle or on the steering wheel 22). In other examples, the one or more switches may include soft switches provided on a touchscreen associated with the infotainment system or another input device. In still other examples, the one or more switches can be actuated automatically in conjunction with a heating, ventilation, and air conditioning (HVAC) system (not shown).

The capacitive sensing controller 24 and the heating controller 26 are separate controllers. That is, the capacitive sensing controller 24 and the heating controller 26 are not connected to each other. The capacitive sensing controller 24 and the heating controller 26 operate independently of each other. The operations of the capacitive sensing controller 24 and the heating controller 26 are not synchronized. The capacitive sensing controller 24 and the heating controller 26 communicate with other vehicle controllers 28 via a vehicle communication bus 30. For example, the other vehicle controllers 28 may include controllers that control a climate control system (e.g., a heating and cooling system), an autonomous vehicle control system, a restraint control system, an infotainment system, and so on. For example, the vehicle communication bus 30 may include a controller area network (CAN) bus, a local interconnect network (LIN) bus, or any other communication bus/network used in the vehicle.

The capacitive sensing controller 24 and the heating controller 26 receive settings from and transmit data to the other vehicle controllers 28 via the vehicle communication bus 30. For example, the capacitive sensing controller 24 receives calibrated thresholds from one or more of the vehicle controllers 28 for capacitance sensing. For example, the heating controller 26 receives calibrated thresholds from one or more of the vehicle controllers 28 for heating control. The structural design of the heater/sensor assembly 42 is shown and described below in further detail with reference to FIGS. 3A-5B. The structural design of the heater/sensor assembly 42 allows the capacitive sensing controller 24 and the heating controller 26 to operate without interfering each other as explained below in further detail.

For example, as shown in FIG. 7, the capacitive sensing controller 24 may include a tank circuit coupled to the capacitive sensor in the heater/sensor assembly 42. The capacitive sensing controller 24 can measure the capacitance or change in the capacitance by measuring a resonant frequency or change in the resonant frequency of the tank circuit. After sensing the capacitance, the capacitive sensing controller 24 can communicate the capacitance measurement to one or more of the other vehicle controllers 28 via the vehicle communication bus 30. In some examples, the autonomous driving control system may use the sensed capacitance measurement to determine whether the driver's hand or hands are on or off the steering wheel.

FIG. 2 shows a capacitive sensing and heating system 50 for a seat 51 of the vehicle. The seat 51 includes a seat portion 52 and a backrest portion 53. A heater/sensor assembly 64 is disposed in the seat portion 52. The heater/sensor assembly 64 may include a single zone or a plurality of zones for heating and/or capacitive sensing.

The capacitive sensing and heating system 50 includes a capacitive sensing controller 54 and a heating controller 56. The capacitive sensing controller 54 senses a capacitance of the heater/sensor assembly 64. Specifically, the capacitive sensing controller 54 senses a change in the capacitance that is induced when an occupant of the vehicle occupies the seat 51 or when the occupant vacates the seat 51. The heating controller 56 controls supply of power to the heater in the heater/sensor assembly 64. In some examples, a switch (not shown) may be used by an occupant of the vehicle to actuate heating of the seat 51. The switch can be similar to that described above with reference to FIG. 1. Therefore, the description of the switch is not repeated for brevity.

The capacitive sensing controller 54 and the heating controller 56 are separate controllers. That is, the capacitive sensing controller 54 and the heating controller 56 are not connected to each other. The capacitive sensing controller 54 and the heating controller 56 operate independently of each other. The operations of the capacitive sensing controller 54 and the heating controller 56 are not synchronized. The capacitive sensing controller 54 and the heating controller 56 communicate with other vehicle controllers 28 via a vehicle communication bus 30. For example, the other vehicle controllers 28 may include controllers that control a climate control system (e.g., a heating and cooling system), an autonomous vehicle control system, a restraint control system, an infotainment system, and so on. For example, the vehicle communication bus 30 may include a CAN bus, a LIN bus, or any other communication bus/network used in the vehicle.

The capacitive sensing controller 54 and the heating controller 56 receive settings from and transmit data to the other vehicle controllers 28 via the vehicle communication bus 30. For example, the capacitive sensing controller 54 receives calibrated thresholds from one or more of the vehicle controllers 28 for capacitance sensing. For example, the heating controller 56 receives calibrated thresholds from one or more of the vehicle controllers 28 for heating control. The structural design of the heater/sensor assembly 64 is similar to the structural design of the heater/sensor assembly 42 shown and described below in further detail with reference to FIGS. 3A-5B. The structural design of the heater/sensor assembly 64 allows the capacitive sensing controller 54 and the heating controller 56 to operate without interfering each other.

For example, as shown in FIG. 7, the capacitive sensing controller 54 may include a tank circuit coupled to the capacitive sensor in the heater/sensor assembly 64. The capacitive sensing controller 54 can measure the capacitance or change in the capacitance by measuring a resonant frequency or change in the resonant frequency of the tank circuit. After sensing the capacitance, the capacitive sensing controller 54 can communicate the capacitance measurement to one or more of the other vehicle controllers 28 via the vehicle communication bus 30. In some examples, the autonomous driving control system may use the sensed capacitance measurement to determine the presence or absence of an occupant in the seat 51.

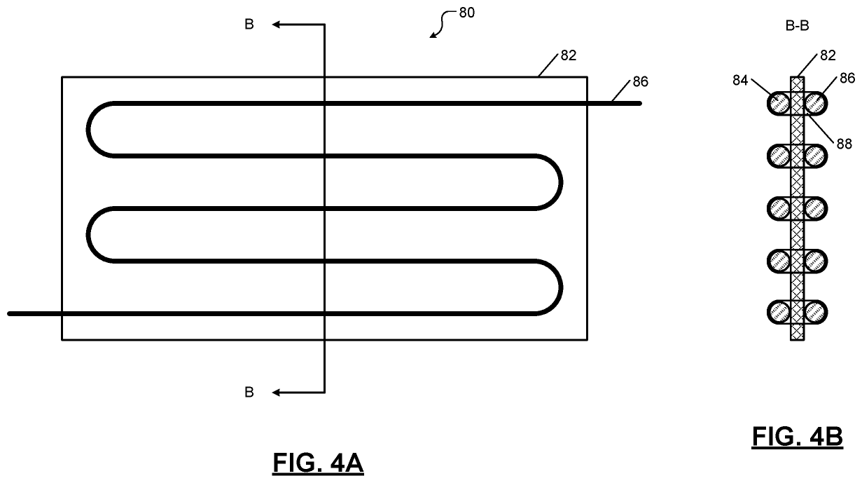

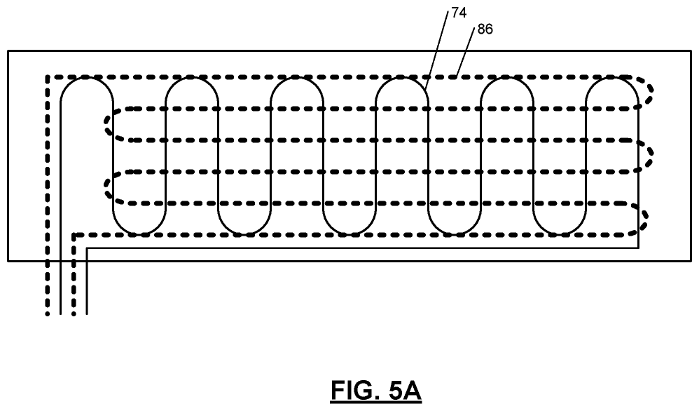

FIGS. 3A-5B show the design and construction of a heater/sensor assembly including the hands on detection sensor and the heater according to the present disclosure. FIGS. 3A and 3B show the sensor portion of the heater/sensor assembly. FIGS. 4A and 4B show the heater portion of the heater/sensor assembly. FIGS. 5A and 5B show the heater/sensor assembly comprising the sensor and heater portions.

FIGS. 3A and 3B show an example of a sensor portion 70 of the heater/sensor assembly 42 according to the present disclosure. FIG. 3A shows a plan view of the sensor portion 70 of the heater/sensor assembly 42. FIG. 3B shows a cross-sectional view of the sensor portion 70 of the heater/sensor assembly 42.

In FIG. 3A, the sensor portion 70 comprises a first sheet (or base) 72 of an electrically non-conducting flexible material (e.g., fleece or a textile material). For example, the first sheet 72 may be rectangular but can be of any other shape. A first wire (also called a sensor wire) 74 is arranged on a first side (i.e., first surface) of the first sheet 72. A second wire (called a first shield wire, shown in FIG. 3B) 76 is arranged on a second side (i.e., second surface) of the first sheet 72. The second side of the first sheet 72 is opposite to the first side of the first sheet 72. For example, the first side of the first sheet 72 is a top side of the first sheet 72, and the second side of the first sheet 72 is a bottom side of the first sheet 72. The first and second wires 74, 76 are arranged symmetrically (e.g., vertically aligned and parallel to each other) on the opposite sides of the first sheet 72. That is, while the first and second wires 74, 76 are arranged on opposite sides of the first sheet 72, the first wire 74 lies directly above and is vertically aligned with the second wire 76.

FIG. 3B shows a cross-sectional view of the sensor portion 70 taken along line A-A shown in FIG. 3A. In FIG. 3B, the first wire 74 and the second wire 76 are sewn together to the first sheet 72 using an electrically non-conductive thread 78. The first and second wires 74, 76 can include single strand or multi strand wires made of an electrically conducting material.

FIGS. 4A and 4B show an example of a heater portion 80 of the heater/sensor assembly 42 according to the present disclosure. FIG. 4A shows a plan view of the heater portion 80 of the heater/sensor assembly 42. FIG. 4B shows a cross-sectional view of the heater portion 80 of the heater/sensor assembly 42.

In FIG. 4A, the heater portion 80 comprises a second sheet (or base) 82 of an electrically non-conducting flexible material (e.g., fleece or a textile material). For example, the second sheet 82 may be rectangular but can be of any other shape. Regardless, the first and second sheets 72, 82 are of the same shape, size, and material. A third wire (also called a second shield wire, shown in FIG. 4B) 84 is arranged on a first side (i.e., first surface) of the second sheet 82. As shown in FIG. 5B, when the sensor portion 70 is stacked on top of the heater portion 80, the first side of the second sheet 82 faces the second side of the first sheet 72, and the third wire 84 of the heater portion 80 is adjacent to the second wire 76 of the sensor portion 70. A fourth wire (called heater wire, shown in FIG. 4B) 86 is arranged on a second side (i.e., second surface) of the second sheet 82. The second side of the second sheet 82 is opposite to the first side of second sheet 82. For example, the first side of second sheet 82 is a top side of the second sheet 82, and the second side of the second sheet 82 is a bottom side of second sheet 82. The third and fourth wires 84, 86 are arranged symmetrically (e.g., vertically aligned and parallel to each other) on the opposite sides of the second sheet 82. That is, while the third and fourth wires 84, 86 are arranged on opposite sides of the second sheet 82, the third wire 84 lies directly above and is vertically aligned with the fourth wire 86.

The third and fourth wires 84, 86 are arranged at an angle relative to the first and second wires 74, 76. For example, the angle can be 90 degrees; that is, the third and fourth wires 84, 86 may be perpendicular to the first and second wires 74, 76. Instead, the angle can be a non-zero angle less than 90 degrees. For example, the angle can be any non-zero acute angle that minimizes the contact or overlap between the second and third wires 76, 84.

FIG. 4B shows a cross-sectional view of the heater portion 80 taken along line B-B shown in FIG. 4A. In FIG. 4B, the third wire 84 and the fourth wire 86 are sewn together to the second sheet 82 using an electrically non-conductive thread 88. The third and fourth wires 84, 86 can include single strand or multi strand wires made of an electrically conducting material.

FIGS. 5A and 5B show the heater/sensor assembly 42 comprising the sensor and heater portions 60, 80. In the heater/sensor assembly 42, the sensor portion 70 is stacked on top of the heater portion 80 such that the second side of the first sheet 72 faces the first side of the second sheet 82, and the first and second shield wires (i.e., the second and third wires) 76, 84 are adjacent to each other. FIG. 5A shows an example layout of the first and fourth wires 74, 86 where the first and fourth wires 74, 86 are arranged perpendicularly to each other although the angle of their relative orientation can be any non-zero acute angle as described above. While not visible, the second wire 76 is parallel to (i.e., vertically aligned with) the first wire 74 and lies directly under the first wire 74, and the third wire 84 is parallel to (i.e., vertically aligned with) the fourth wire 86 and lies directly above the fourth wire 86.

In some implementations, the second and third wires 76, 84 are grounded. In other implementations, at least one of the second and third wires 76, 84 is driven actively by a respective signal (e.g., a first signal output by the capacitive sensing controller 24 and a second signal output by the heating controller 26). When at least one of the second and third wires 76, 84 is actively driven by a signal, the second and third wires 76, 84 are electrically insulated. Alternatively, instead using electrically insulated wires, a layer of an electrically non-conducting material is disposed between the second and third wires 76, 84. The second and third wires 76, 84 provide effective shield between the first and fourth wires (i.e., the sensor and heater wires) 74, 86. Further, the angled orientation between the first and second wires 74, 76 and the third and fourth wires 84, 86 provide minimum overlap between the first and second wires 74, 76 and the third and fourth wires 84, 86. The minimum overlap minimizes any remaining interference not prevented by the second and third wires 76, 84 and allows control of the sensor and heater wires (i.e., the first and fourth wires) 74, 86 using respective independent and non-synchronized controllers. Examples of the controllers are shown and described below with reference to FIG. 7.

When the heater/sensor assembly 42 is disposed in the steering wheel 22 of the vehicle, the heater/sensor assembly 64 performs heating and proximity sensing in the steering wheel 22 as follows. The sensor wire (i.e., the first wire) 74 is disposed proximate to and facing an outer periphery of the steering wheel 22. When an occupant places hands on the steering wheel 22, the sensor portion 70 senses a change in capacitance, which is measured by the capacitive sensing controller 24 as described below with reference to FIG. 7. The heater wire (i.e., the fourth wire) 86 is adjacent to the steering wheel base 40 and heats the steering wheel 22 when activated by the heating controller 26 as described below with reference to FIG. 7.

The heater/sensor assembly 64 is similar to the heater/sensor assembly 42. When disposed in the seat portion 52 of the seat 51, the heater/sensor assembly 64 performs heating of an upper surface of the seat portion 52 and proximity sensing in the seat portion 52 as follows. The sensor wire (i.e., the first wire) 74 is proximate to and facing an upper region of the seat portion 52. When an occupant occupies the seat 51, the occupant rests on the upper region of the seat portion 52. When an occupant occupies or vacates the seat 51, the sensor portion 70 senses a change in capacitance, which is measured by the capacitive sensing controller 24 as described below with reference to FIG. 7. The heater wire (i.e., the fourth wire) 86 faces a lower region of the seat portion 52, which faces a chassis of the vehicle. The heater wire 86 heats the seat portion 52 when activated by the heating controller 26 as described below with reference to FIG. 7.

FIG. 6 schematically shows a manner in which the heater/sensor assembly 42 is embedded in the steering wheel 22 and the heater/sensor assembly 64 is embedded in the seat portion 52. When the heater/sensor assembly 42 is disposed in the steering wheel 22, a first adhesive layer 100 is arranged between the top of the heater/sensor assembly 42 and a cover layer 90. For example, the cover layer 90 can be made of leather or other suitable electrically non conducting material. The first adhesive layer 100 adheres the top of the heater/sensor assembly 42 to the inside of the cover layer 90. The first adhesive layer 100 is proximate to the sensor wire (i.e., the first wire) 74 of the heater/sensor assembly 42. A second adhesive layer 112 is arranged between the bottom of the heater/sensor assembly 42 and the steering wheel base 40. The second adhesive layer 112 adheres the bottom of the heater/sensor assembly 42 to the steering wheel base 40. The second adhesive layer 112 is proximate to the heater wire (i.e., the fourth wire) 86 of the heater/sensor assembly 42. The first and second adhesive layers 100, 112 are electrically non-conducting.

The heater/sensor assembly 64 is disposed in a lower region of the seat portion 52. The second adhesive layer 112 is disposed on the bottom of the heater/sensor assembly 64. The second adhesive layer 112 adheres the bottom of the heater/sensor assembly 64 to the lower region of the seat portion 52. The second adhesive layer 112 is proximate to the heater wire (i.e., the fourth wire) 86 of the heater/sensor assembly 64. The cover layer 90 is arranged in the upper region of the seat portion 52 adjacent to the sensor wire (i.e., the first wire) 74 (i.e., on the top) of the heater/sensor assembly 64. For example, the cover layer 90 can include the upper surface (e.g., upholstery) of the seat portion 52 and is electrically non-conducting. The first adhesive layer 100 is disposed on top of the heater/sensor assembly 64 between the cover layer 90 and the sensor wire 74. The first adhesive layer 100 adheres the top of the heater/sensor assembly 64 to the inside of the cover layer 90. The first adhesive layer 100 is proximate to the sensor wire (i.e., the first wire) 74 of the heater/sensor assembly 64. The first and second adhesive layers 100, 112 are electrically non-conducting.

For completeness, simplified non-limiting examples of the capacitive sensing controller 24 and the heating controller 26 are shown and described with reference to FIG. 7. The capacitive sensing controller 54 and the heating controller 56 can be similar to the capacitive sensing controller 24 and the heating controller 26. In some implementations, the capacitive sensing controller 24 and the heating controller 26 can be combined into a single controller. Similarly, the capacitive sensing controller 54 and the heating controller 56 can also be combined into a single controller.

In FIG. 7, a capacitive sensing and heating system 150 includes a heater/sensor assembly 151. The heater/sensor assembly 151 can include the heater/sensor assembly 42 or the heater/sensor assembly 64. The capacitive sensing and heating system 150 comprises the capacitive sensing controller 24 and the heating controller 26. While a single zone circuit will be described below for purposes of illustration and clarity, additional zones can be readily added.

The heating controller 26 comprises a heater driver circuit 158 that selectively supplies power from a voltage source 160 to the heater wire 86 to heat the steering wheel 22 or the seat 51. The heater driver circuit 158 supplies power to the heater wire 102 independently of the capacitive sensing controller 24.

The capacitive sensing controller 24 comprises an excitation circuit 170 that selectively outputs an excitation signal (such as a square wave or other waveform shape) to an LC tank circuit 172 that is connected to the sensor wire 74. A frequency measurement circuit 178 measures the resonant frequency of the LC tank circuit 172. When an occupant's hand (or body in case of the seat implementation) is proximate to the sensor wire 74, the capacitance of the combined circuit varies. The variation in capacitance due to the presence or absence of the occupant's hands on the steering wheel (or due to the presence or absence of the occupant in the seat 51) affects a resonant frequency of the LC tank circuit 172. The capacitive sensing controller 24 measures the variation in capacitance based on the changes in the resonant frequency of the LC tank circuit 172.

Based on the variation in the capacitance, the capacitive sensing controller 24 detects the presence or absence of the occupant's hands on the steering wheel (or due to the presence or absence of the occupant in the seat 51). The capacitive sensing controller 24 measures the variation in capacitance independently of the heating controller 26. That is, the operations of the capacitive sensing controller 24 and the heating controller 26 are not and need not be synchronized. The capacitive sensing controller 54 and the heating controller 56 operate similar to the capacitive sensing controller 24 and the heating controller 26.

The second and third wires (i.e., the shield wires) 76, 84 provide an electrical shield and reduce the effect of stray capacitance between the sensor wire (i.e., the first wire) 74 and the heater wire (i.e., the fourth wire) 86. At least one of the second and third wires (i.e., the shield wires) 76, 84 can be connected to ground. Alternatively, at least one of the second and third wires 76, 84 can be driven by an active signal while the other one of the second and third wires 76, 84, if not driven by an active signal, may be connected to ground. For example, at least one of the second and third wires (i.e., the shield wires) 76, 84 can be driven by the signal output to the sensor wire 72 by the capacitive sensing controller 26. Alternatively, or additionally, at least one of the second and third wires (i.e., the shield wires) 76, 84 can be driven by respective signals output to the sensor and heater wires 74, 86 by the capacitive sensing and heating controllers 24, 26. When at least one of the second and third wires 76, 84 is actively driven by a signal, the second and third wires 76, 84 are electrically insulated. Alternatively, when at least one of the second and third wires 76, 84 is actively driven by a signal, instead using electrically insulated wires, a layer of an electrically non-conducting material is disposed between the second and third wires 76, 84 to electrically isolate the second and third wires 76, 84.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between controllers, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “controller” may be replaced with the term “circuit.” The term “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The controller may include one or more interface circuits. In some examples, the interface circuits may include wired or wireless interfaces that are connected to a local area network (LAN), the Internet, a wide area network (WAN), or combinations thereof. The functionality of any given controller of the present disclosure may be distributed among multiple controllers that are connected via interface circuits. For example, multiple controllers may allow load balancing.

The term code, as used above, may include software, firmware, and/or microcode, and may refer to programs, routines, functions, classes, data structures, and/or objects. The term shared processor circuit encompasses a single processor circuit that executes some or all code from multiple controllers. The term group processor circuit encompasses a processor circuit that, in combination with additional processor circuits, executes some or all code from one or more controllers. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple controllers. The term group memory circuit encompasses a memory circuit that, in combination with additional memories, stores some or all code from one or more controllers.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A heater/sensor assembly to perform heating of a surface and proximity sensing, comprising:
a sensor assembly comprising:
a first sheet of an electrically non-conducting material;
a first wire attached to a first side of the first sheet; and
a second wire arranged parallel to the first wire and attached to a second side of the first sheet that is opposite the first side; and
a heater assembly arranged adjacent to the sensor assembly, the heater assembly comprising:
a second sheet of the electrically non-conducting material arranged parallel to the first sheet;
a third wire attached to a first side of the second sheet facing the second side of the first sheet; and
a fourth wire arranged parallel to the third wire and attached to a second side of the second sheet that is opposite the first side of the second sheet,
wherein the third and fourth wires are arranged at an angle relative to the first and second wires.

2. The heater/sensor assembly of claim 1 wherein the angle is greater than zero and less than or equal to 90 degrees.

3. The heater/sensor assembly of claim 1 wherein the second and third wires contact each other.

4. The heater/sensor assembly of claim 1 wherein the first, second, third, and fourth wires are made of an electrically conducting material and are electrically uninsulated.

5. The heater/sensor assembly of claim 1 wherein the second and third wires are made of an electrically conducting material and wherein one of the second and third wires is electrically insulated.

6. The heater/sensor assembly of claim 1 wherein the second and third wires are made of an electrically conducting material and wherein at least one of the second and third wires is electrically uninsulated, the heater/sensor assembly further comprising a layer of an electrically non-conducting material disposed between the second and third wires.

7. A system comprising:
the heater/sensor assembly of claim 1;
a first circuit configured to control power supply to the fourth wire; and
a second circuit configured to output a signal to the first wire and to sense a capacitance based on a frequency of the signal.

8. The system of claim 7 wherein the first circuit and the second circuit operate independently of each other.

9. The system of claim 7 wherein the second and third wires are connected to a reference potential.

10. The heater/sensor assembly of claim 7 wherein the second and third wires are made of an electrically conducting material, wherein one of the second and third wires is electrically insulated, and wherein at least one of the first circuit and the second circuit outputs a respective signal to the second and third wires.

11. The system of claim 7 wherein the second and third wires are made of an electrically conducting material and are uninsulated, the heater/sensor assembly further comprising a layer of an electrically non-conducting material disposed between the second and third wires, wherein at least one of the first circuit and the second circuit outputs a respective signal to the second and third wires.

12. The heater/sensor assembly of claim 1 wherein at least one of the first, second, third, and fourth wires includes a single strand wire.

13. The heater/sensor assembly of claim 1 wherein at least one of the first, second, third, and fourth wires includes a multi-strand wire.

14. A steering wheel of a vehicle comprising:
the heater/sensor assembly of claim 1;
a cover layer arranged adjacent to the first wire, the cover layer being electrically non-conducting;
a first adhesive layer disposed between the cover layer and the first wire to adhere the first wire to the cover layer, the first adhesive layer being electrically non-conducting; and
a second adhesive layer disposed between the fourth wire and a base portion of the steering wheel to adhere the fourth wire to the base portion of the steering wheel, the second adhesive layer being electrically non-conducting.

15. A system comprising:
the steering wheel of claim 14;
a first circuit configured to control power supply to the fourth wire; and
a second circuit configured to output a signal to the first wire and to sense a capacitance based on a frequency of the signal.

16. The system of claim 15 wherein the first circuit and the second circuit operate independently of each other.

17. A seat of a vehicle comprising:
the heater/sensor assembly of claim 1 disposed in a seat portion of the seat of the vehicle, the first wire being proximate to and facing an upper region of the seat portion, the fourth wire facing a lower region of the seat portion;
a cover layer arranged in the upper region of the seat portion adjacent to the first wire, the cover layer being electrically non-conducting;
a first adhesive layer disposed between the cover layer and the first wire to adhere the first wire to the cover layer, the first adhesive layer being electrically non-conducting; and
a second adhesive layer disposed between the fourth wire and the lower region of the seat portion to adhere the fourth wire to the lower region of the seat portion, the second adhesive layer being electrically non-conducting.

18. A system comprising:
the seat of claim 17;
a first circuit configured to control power supply to the fourth wire; and
a second circuit configured to output a signal to the first wire and to sense a capacitance based on a frequency of the signal.

19. The system of claim 18 wherein the first circuit and the second circuit operate independently of each other.
